(19) United States
(12) Patent Application Publication
(10) Pub. No.: US 2009/0127278 A1
(43) Pub. Date: May 21, 2009

(54) Ejection device

(75) Inventors: Christian Hefele, Breitenbrunn (DE); Hans Peter Lederle, Durach (DE); Peter Ostermeier, Diessen (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/291,095

(22) Filed: Nov. 5, 2008

(30) Foreign Application Priority Data
Nov. 21, 2007 (DE) 10 2007 055 501.8

(51) Int. Cl. G07F 11/00

(52) U.S. Cl. 221/248

(57) ABSTRACT

An ejection device (11) for containers (36) containing compounds has an ejection unit (12) and a receiving chamber (16) for the container (36) and which is defined on, one side, by the ejection unit (12) and on the other side, by a front plate (26) which is arranged at a distance from the ejection unit (12). The front plate (26) is pivotable around a pivot point (28) defining a pivot axis (27) from an open position in which the container (36) can be inserted into the receiving chamber (16), to a closed position in which the container (36) is held in the receiving chamber (16). A snap lock with flexible snap-in member (31) and a rigid holding member (29) is provided at a distance from the pivot point (28) on the front plate (26) for locking the front plate (26) in the closed position and cooperating with snap receptacle (22) arranged at the ejection device (11) for receiving the snap-in member (31).

### BACKGROUND OF THE INVENTION

1. Field of the Invention

The present invention relates to an ejection device for containers containing compounds and including an ejection unit with a receiving chamber for the container and which is defined, on one side, by the ejection unit and, on the other side, by a front plate which is spaced from the ejection unit, with the front plate being pivotable around a pivot point, which defines a pivot axis, from an open position in which the container is insertable into the receiving chamber, to a closed position in which the container is held in the receiving chamber, and with a snap lock with flexible snap-in member element provided at a distance from the pivot point on the front plate for locking the front plate in its closed position to a snap receptacle provided in the ejection device for receiving the snap-in member.

2. Description of the Prior Art

An ejection device of the type mentioned above is used for dispensing compounds, such as mortar compounds or sealing compounds, which are packaged in containers, at an application site. Containers are, for example, cartridges with one or more receiving chambers for one or more components of the compound to be applied which are provided directly or packaged, e.g., in foil bags, in the receiving chambers of the cartridge. The expression “container” further includes foil bags which are filled with one or more components of the compound to-be-applied and which are inserted in a separate receiving body or in a receiving body arranged at the ejection device.

The ejection unit of the ejection device usually has a forward feed mechanism whose actuation causes a forward feed member, e.g., a piston rod, to be displaced by a predetermined distance. Pressure transmission member, e.g., a piston, which is arranged at the piston rod, acts on the compound located in the container so that a corresponding amount of the compound is dispensed through a dispensing opening with every advance of the piston.

U.S. Pat. No. 6,371,938 B1 discloses an ejection device for containers containing compounds which has, on the front side, a front plate that can be pivoted from an open position into a closed position around a pivot point defining a pivot axis. In the open position, a new container may be inserted into the receptacle or a squeezed-out container can be removed from the receptacle. In the closed position, the container is held in the receptacle during the ejection process in direction of the ejection unit. A snap lock with a U-shaped, flexible snap-in member is provided at a distance from the pivot point at the front plate for locking the front plate in the closed position at a snap receptacle which is formed as a pin and which is arranged on the ejection device.

The known solution is disadvantageous in that high forces act on the pivotable front plate during the ejection process, particularly for mortar and sealing compounds. These forces are transmitted to the ejection device via the snap lock. In so doing, the flexible snap-in member can be deformed and the snap lock can disengage so that the front plate can pivot from the closed position into the at least partially open position unintentionally. This interferes with the ejection process and costs the user extra effort.

### SUMMARY OF THE INVENTION

It is the object of the present invention to provide an ejection device for containers containing compounds with a pivotable front plate which is securely held in the closed position during the entire ejection process.

This and other objects of the present invention, which will become apparent hereinafter, are achieved by providing, according to the invention, a snap lock having a rigid holding member in addition to the flexible snap-in member.

Forces acting on the front plate can be transmitted to the ejection device by the rigid holding member during the ejection process without substantial deformation of the snap lock. Through the combination of the rigid holding member and the flexible snap-in member, the front plate is prevented from unintentionally disengaging during the entire ejection process and in different orientations of the ejection device. Further, the front plate is pivotable from the closed position into the open position again in a simple manner because the snap lock can be opened by being pressed in the corresponding pivot direction.

Rigid holding member in this connection represents a holding member that is fashioned from a material having a greater rigidity in comparison to the material of the flexible snap-in member. The rigid holding member is advantageously made of the same material as the front plate.

The flexible snap-in member preferably projects into some areas of a holding recess formed by the rigid holding member for a snap receptacle formed as a pin, with the flexible snap-in member advantageously engaging behind the pin. In a particularly advantageous manner, the flexible snap-in member is provided at the free end of an advantageously U-shaped holding recess of the rigid holding member, which ensures a simple locking and unlocking of the pivotable front plate and a reliable holding of the same in the closed position.

The flexible snap-in member is preferably formed as a springy element, which enables a simple unlocking of the front plate and ensures that the front plate is adequately secured for being retained in the closed position. For example, the flexible snap-in member is made of a spring steel and is formed in accordance with the design of the snap receptacle.

The flexible snap-in member is preferably made of elastic material which advantageously has a sufficient flexibility for tilting away or deflecting during the locking and unlocking of the front plate.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a plan view of the ejection device according to the present invention with inserted container;

FIG. 2 a front elevational view of the ejection device with the front plate in the open position; and

FIG. 3 a cross-sectional enlarged view along line III-III in FIG. 1 with the front plate in the closed position.

In principle, identical parts are provided with identical reference numerals in the drawings.

### DETAILED DESCRIPTION OF THE PREFERRED EMBODIMENT

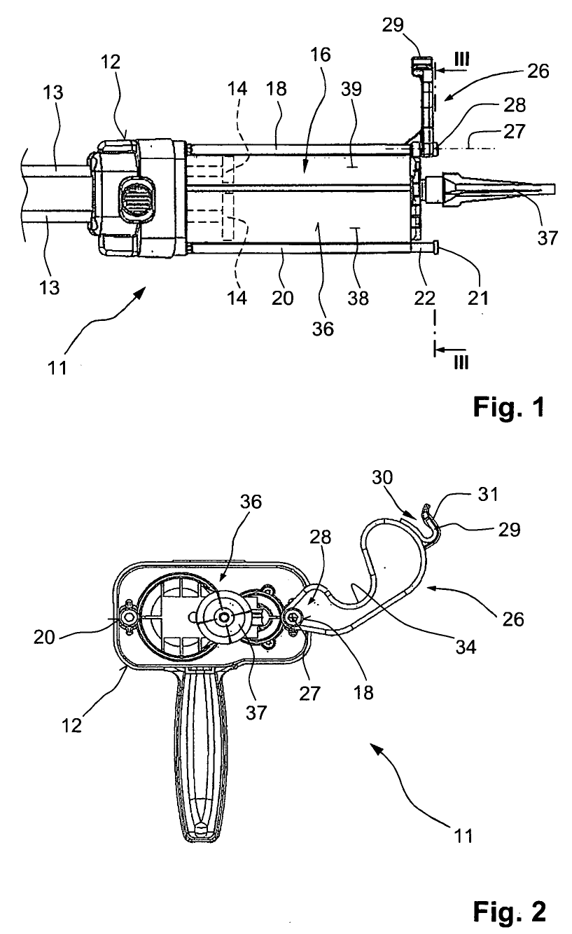

An ejection device 11 according to the present invention for containers 36 containing compounds, which is shown in FIGS. 1 to 3, has an ejection unit 12 with two piston rods 13, at which a pressure piston 14 is provided in each instance, and a receiving chamber 16 for the container 36. The container 36 is a cartridge for a multi-component compound and has a first receiving part 38 with a component A and a second receiving part 39 with a component B. When the ejection unit 12 is actuated, the piston rods 13 with the pressure pistons 14 are displaced, and the components of the multi-component compound located in the container 36 are dispensed, e.g., through a mixer housing 37, at the desired application site.

The receiving chamber 16 is defined on one side by the ejection unit 12, and, on the other side, by a front plate 26 which is spaced from the ejection unit 12. Connecting rods 18 and 20, which extend parallel to the ejection unit of the ejection device 11, are provided at the sides. These connecting rods 18 and 20 extend from the ejection unit 12 and their free ends 19 and 21 project over the container 36 which is inserted in the receiving chamber 16 without the mixer housing 37. The front plate 26 has a recess 34 which is open on one side and which partially encompasses, in the closed position, the mixer housing 37 of the container 36 inserted in the receiving chamber 16.

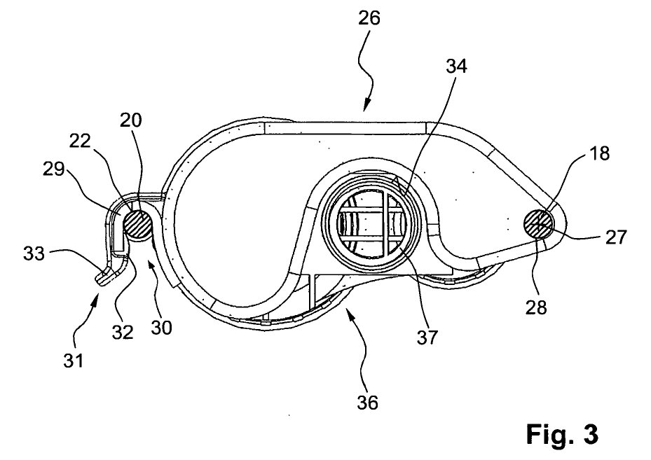

The front plate 26 is pivotable around a pivot point 28, which lies on a pivot axis 27 extending along the longitudinal extension of one connecting rod 18, from an open position for inserting the container 36 into the receiving chamber 16 (see FIG. 2) to a closed position for holding the container 36 in the receiving chamber 16 (see FIG. 3). A circumferentially extending projection is provided at the free end 21 of the other connecting rod 20, behind which a snap receptacle 22 for the pivotable front plate 26, which face the ejection unit 12, is formed. Provided at a distance from the pivot point 28, at the front plate 26, is a snap lock with a U-shaped rigid holding member 29 having a holding recess 30 for locking the front plate 26 in the closed position at the snap receptacle 22 arranged on the ejection device 11, and flexible snap-in member 31 which additionally fixes the front plate 26 in a clamping manner at the snap receptacle 22. The flexible snap-in member 31 is formed as a springy element and is made of an elastic material. The flexible snap-in member 31 has a bulge 32 in the area of the free end of the holding member 29. The bulge 32 projects into the holding recess 30 of the rigid holding member 29, and accordingly, holds the front plate 26 securely at the snap receptacle 22 with an undercut. Further, an outwardly protruding hand grip 33 is provided at the flexible snap-in member 31 and with which the flexible snap-in element 31 can be pivoted outward for unlocking the front plate 26 in a simple manner.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. An ejection device for containers (36) containing compounds, comprising a chamber (16) for receiving a container (36); an ejection unit (12) limiting the receiving chamber on one side; a front plate (26) spaced from the ejection unit (12) and limiting the receiving chamber (36) on another side, the front plate (26) pivoting around a pivot point (28) defining a pivot axis (27) between an open position in which the container (36) can be inserted in the receiving chamber (16), and a closed position in which the container (36) is retained in the receiving chamber (36); and a snap lock provided on the front plate (26) at a distance from the pivot point (28) and cooperating with a snap receptacle (22), which is provided on the ejection device, for locking the front plate (26) in the closed position thereof, the snap lock having a flexible snap-in member (31) and a rigid holding member (29).

2. An ejection device according to claim 1, wherein the snap receptacle (22) is formed as a pin, wherein the rigid holding member (29) forms a holding recess (30) for receiving the pin, and wherein the flexible member (31) projects, at least partially, in the holding recess (30).

3. An ejection device according to claim 1, wherein the flexible snap-in member (31) is formed as a springy member.

4. An ejection device according to claim 1, wherein the flexible snap-in member (31) is made of an elastic material.
